(19) United States
(12) Patent Application Publication
(10) Pub. No.: US 2014/0269226 A1
(43) Pub. Date: Sep. 18, 2014

(54) PRESSURE ACTUATED TIMING APPARATUS FOR USE WITH GAMES AND THE LIKE

(71) Applicant: Arlen J. Lowrance, Edmond, OK (US)

(72) Inventor: Arlen J. Lowrance, Edmond, OK (US)

(21) Appl. No.: 13/834,564

(22) Filed: Mar. 15, 2013

(51) Int. Cl. A63F 11/00; G04F 10/00

(52) U.S. Cl. CPC A63F 11/00; G04F 10/00
USPC 368/110

(57) ABSTRACT

There is provided a pressure actuated timing device for use with activities such as games. In some embodiments, the electrical component of the invention will comprise a conventional “tap light” (or “tap-on-light”) in electronic communication with a digital or other stopwatch or electronic timer. Additionally, a game player will be equipped with a rubber ball or similar lightweight and resilient object (e.g., a bean bag, a soft plastic toy, etc.) that may be attached to the user's hand via an elastic tether. In some embodiments, the object will be to strike the tap light with a thrown object in a minimal period of time.

### FIELD OF THE INVENTION

The instant invention generally relates to timing devices for use with an activity such as a game and, more particularly, to pressure actuated timing devices that can be utilized with children and adult games and the like.

### BACKGROUND OF THE INVENTION

There are any number of timing devices that have been marketed for use in connection with games. However, such timing devices have typically focused on timing an unrelated event (e.g., a chess clock is used to time the moves of each opponent) rather than being a specific component of the game itself. Said another way, in many games the timer is used to limit a participant's time in another activity, rather than having the time necessary to perform a task being an object of the game.

Thus, if the object is to perform a particular task in a minimal time (and the winner is determined from this time) many games do not offer this option.

Another problem that is frequently observed even with games or other activities that have a participant's time as a scoring factor is that, because of the nature of the timing device, a third party must actually activate/deactivate the timer. This might be for many reasons but one is that a conventional timing device such as a stopwatch can only be started and stopped by pressing a small button on the body of the device which tends to limit its usefulness as a game piece. Further, if the object is to perform a task in a minimal time and the user who is performing the task is responsible for activating/deactivating the stopwatch, there might be a tendency to delay activating the device after the start of performance in the hope that the elapsed time will be reduced. Such activity during self-timing cannot easily be detected with a conventional stopwatch which might be held in a user's hand during the performance of the assigned task.

Heretofore, as is well known in the gaming arts, there has been a need for an invention to address and solve the disadvantages of prior art methods. Accordingly, it should now be recognized, as was recognized by the present inventors, that there exists, and has existed for some time, a very real need for a system and method that would address and solve the above-described problems.

Before proceeding to a description of the present invention, however, it should be noted and remembered that the description of the invention which follows, together with the accompanying drawings, should not be construed as limiting the invention to the examples (or preferred embodiments) shown and described. This is so because those skilled in the art to which the invention pertains will be able to devise other forms of the invention within the ambit of the appended claims.

### SUMMARY OF THE INVENTION

According to an aspect of the invention, there is provided a pressure actuated timing device for use with activities such as games. In some embodiments, the electrical component of the invention will comprise a conventional “tap light” (or “tap-on-light) in electronic communication with a digital or other stopwatch or electronic timer. Additionally, a game player will be equipped with a rubber ball or similar lightweight and resilient object (e.g., a bean bag, a soft plastic toy, etc.) that may be attached to the user's hand via an elastic tether. In some embodiments, a tether will not be used.

In one variation tapping on the tap light will make ready the stopwatch. In some embodiments, this will also activate the light within the tap light, if such is present. Next (and preferably) a second tap on the tap light will turn the light off and activate the stopwatch which will continue to accumulate time until a first tap turns the light back on and a further tape stops the timing. This particular wiring configuration might be useful where the instant invention is used to measure eye-hand coordination, with the resulting time being indicative of a user's ability to quickly tap a target.

In another variation, the tap light/stopwatch might be activated by, for example, or other non-participant, at which point the stopwatch will run continuously while a user seeks to strike the light with a thrown object. In instances where the thrown object is attached to the user by a tether, the user will easily be able to recall the thrown item for a subsequent toss if the previous toss did not stop the timer. The user will continue to throw objects (either the same object that has been recalled via tether or a different object of the same kind as was thrown previously) until the light is struck and the timer has been thereby stopped. The time that registers on the timing device will be the user's score, with lower times being preferred to longer ones.

In another variation, tapping the light will turn on its internal light (if present) and activate the associated timing device. The stopwatch will then continue to run until the tap light is tapped again, at which time the light will be extinguished and the timer stopped. In one preferred embodiment, this configuration could be used to measure reaction time.

The foregoing has outlined in broad terms the more important features of the invention disclosed herein so that the detailed description that follows may be more clearly understood, and so that the contribution of the instant inventors to the art may be better appreciated. The instant invention is not limited in its application to the details of the construction and to the arrangements of the components set forth in the following description or illustrated in the drawings. Rather the invention is capable of other embodiments and of being practiced and carried out in various other ways not specifically enumerated herein. Additionally, the disclosure that follows is intended to apply to all alternatives, modifications and equivalents as may be included within the spirit and the scope of the invention as defined by the appended claims. Further, it should be understood that the phraseology and terminology employed herein are for the purpose of description and should not be regarded as limiting, unless the specification specifically so limits the invention.

### BRIEF DESCRIPTION OF THE DRAWINGS

Other objects and advantages of the invention will become apparent upon reading the following detailed description and upon reference to the drawings in which:

FIG. 1 is an illustration of how an embodiment of the instant invention might be used in practice.

FIG. 2 is a schematic diagram of one embodiment of the invention of the present disclosure.

FIG. 3 is a flow chart illustrating one method of operation of the invention of the present disclosure.

FIG. 4 is a flow chart illustrating another method of operation of the invention of the present disclosure.

FIG. 5 is a schematic diagram of another embodiment of the invention of the present disclosure.

FIG. 6 is a flow chart illustrating a method of operation of the invention of the present disclosure as shown in FIG. 5.

FIG. 7 is a schematic illustration of a wireless embodiment of the instant invention.

FIG. 8 is a schematic illustration of how an embodiment of the instant invention might be utilized in combination with a protective structure.

### DETAILED DESCRIPTION OF THE PREFERRED EMBODIMENTS

While this invention is susceptible of embodiment in many different forms, there is shown in the drawings, and will be described hereinafter in detail, some specific embodiments of the instant invention. It should be understood, however, that the present disclosure is to be considered an exemplification of the principles of the invention and is not intended to limit the invention to the specific embodiments or algorithms so described.

Turning first to FIG. 1 wherein a preferred embodiment is illustrated, generally speaking, the instant invention 100 can be viewed as a “tap light” 110 (or “tap-on-light”) in combination with a digital stopwatch 120. The stopwatch 120 can be any electronic timer capable of receiving start/stop signals from an outside source. As can generally be seen in this figure, in a preferred arrangement, the tap light 110 and digital stopwatch 120 will be interconnected by an electrical line 115 which conveys signals from the tap light 110 to the stopwatch 120. Although this embodiment utilizes an electrical line 115 to connect the tap light 110 and the stopwatch 120, a wired connection is not strictly necessary and other embodiments of the invention may utilize a wireless (e.g., Bluetooth, WiFi, etc.) connection. All that is required is that the tap light 110 and the stop watch 120 be able to communicate with each other, i.e., be in electrical communication.

As is customary with such tap light 110, one surface is surmounted by a translucent plastic cover or globe 105 under which is a light source of some sort, said light often being powered by batteries that are internal thereto. The instant tap light 110 will be activated (i.e., the light will be turned on) and deactivated (i.e., the light will be turned off) by “tapping” on the plastic globe 105. It will be appreciated that a tap light is only one embodiment of a switchable light source that may be utilized with various embodiments of the present disclosure, as other easily switchable light sources could also be utilized.

Additionally, in some embodiments, the instant invention will include a soft weight 140 (e.g., a rubber ball or some similar lightweight and resilient object) that is attached to a user's hand by a tether 130. Preferably, the tether 130 will be elastic or otherwise resilient and will produce a bungee-type effect which allows a user to throw the object 140 at the tap light 110 and have the object 140 returned to the user thereafter via the elasticity of the bungee element 130.

The tap light 110/stopwatch 120 combination is designed in such a way that a tap on the globe 105 will be registered by the stopwatch 120 via electrical connection 115. In some embodiments, the tap light 110 and stopwatch 120 may be in spaced apart locations connected by electrical connections 115. In one embodiment, the instant invention will operate as follows: Tapping on the globe 105 of the tap light 110 will make ready the stopwatch 120. In some embodiments, this will also activate the light (e.g., place it in an illuminated state). Next (and preferably) a second tap on the tap light 110 will turn the light off and activate the stopwatch 120. Tapping again on the globe 105 will turn the light back on and make the stopwatch 120 ready for stopping. Finally, a further tap on the globe 105 will stop the timing stopwatch 120 and allow its value to be read. This particular wiring configuration might be useful where the instant invention 100 is used to measure eye-hand coordination, with the resulting time being indicative of a user's ability to quickly tap a target.

In practice, the instant invention 100 will be useful in connection with the elastic tether 130 and the rubber or other object 140 in a game-type setting. By way of explanation, in one embodiment the tap-on light 110 will be manually activated by, for example, a referee or other nonparticipant. That will activate the stopwatch 120 which will run continuously while a user attempts to strike the tap light 110 with the object 140. Because of the elastic connection 130 between the object 140 and the user, if the throw is inaccurate, the user will be able to quickly retrieve the object 140 and attempt to strike the dome 105 again. The next time the dome 105 is compressed, that will be a signal to the stopwatch 120 to stop running. The time necessary to deactivate the stopwatch 120 will be the user's score for that round, with the user having the lowest time being adjudicated the winner.

In a second embodiment, tapping the tap light 110 will turn the associated light 105 on and activate the stopwatch 120. The stopwatch 120 will continue to run until the tap light 110 is tapped again, at which time the light 105 will be extinguished. In one preferred embodiment, this configuration could be used to measure reaction time.

Of course, the above hardware could be used in many other instances and in many other ways. Still, the key component of the instant invention is the combination of a tap light 110 and a stopwatch 120 which are connected by an electrical connection 115. Note that, in some embodiments, the electrical connection 115 might be wireless (e.g., the Bluetooth or other wireless protocol) but in the preferred embodiment, the connection 115 will be an electrical line.

Referring now to FIG. 2, a schematic diagram of one embodiment of the invention of the present disclosure is shown. The game system 200 comprises at least one tap light 110. The tap light 110 may contain a light bulb 204, which may be incandescent, LED, or based on another technology. The bulb 204 may be stored below a plastic cover, dome, or globe 105 (not shown) that acts as a dispersing lens for light generated by the bulb 204, and also controls a switch 208 that activates and deactivates the bulb 204. To that end, the switch function is shown schematically by the single pole, single throw (SPST) switch 208.

The tap light may have its own internal power supply such as battery 206. The battery 206 may be disposable or rechargeable and may also be user replaceable or serviceable. The light bulb 204 is electrically connected to the battery 206 via the switch 208. In the present embodiment, the light bulb 204 connects to the battery 206 via the negative terminal.

The stopwatch 120 associated with the system 200 may be mounted on a housing 210. In the present embodiment, the housing 210 is tubular allowing it to be easily manipulable by a user, but in other embodiments it may take on other shapes. The housing 210 may be plastic or another resilient material. The housing 210 and the associated components may be spaced apart from the tap light 110.

Contained within the housing is a battery 214. Again, the battery 214 may be disposable or rechargeable, and may also be user serviceable. Also contained within the housing, or mounted to the outside thereof, is a buzzer 224. The buzzer 224 may be a piezoelectric device, a rotational type buzzer, or another type of buzzer. The buzzer 224 may be powered by the battery 214 in the housing 210. Although various batteries and power supplies are described with respect to the particular embodiments disclosed, one of skill in the art will understand that other power supplies may be useful in other embodiments. For example, a DC adapter could be utilized to power the tap light 110 and/or the functionality of the stopwatch 120 and buzzer 224.

A number of user accessible controls may be provided on the housing 210 and/or the stopwatch 120. For example, a momentary switch 222 may be configured as a switch to complete the circuit between the buzzer 224 and battery 214. In at least some instances, the momentary switch can also provide signal to the stopwatch 120 from the battery 206 inside the tap light 110 to begin keeping time, which is important as explained below. It will be appreciated that, in the present embodiment, the switch 222 is a dual pole dual throw (DPST) switch that segregates the circuitry of the buzzer 224 from that of the stopwatch 120, while allowing both to be controlled with a single physical switch. The switch 222 may be a spring-biased push-button switch such that the respective circuits are closed when the switch 222 is pressed, but open again when the switch 222 is released.

The stopwatch 120 may be a commercially available stopwatch that provides for electronic signaling for start/stop functionality. The stopwatch 120 could also be a stopwatch without the capability for receiving a signal from an outside switch that has been properly modified by one skilled in the art to accept the same. The stopwatch 120 may also possess its own separate physical switch for start and stop but the same will be unused in various embodiments of the present disclosure. However, reset and lap buttons may be present and can be utilized with system of the present disclosure for resetting the stopwatch 120 and the like.

Because it may not be desirable to have a continuous voltage signal (or current) applied to the stopwatch 120, a diode 207 interposes the battery 206 and the stopwatch 120, which will prevent current flow under steady state (e.g., when the switch 222 has not just been pressed) but allow an initial, temporary voltage increase to signal the stopwatch 120. The diode 207 also provides additional important functionality with regard to the operation of the tap light switch 208 to signal the stopwatch 120 to stop keeping time. For example, when the tap light 110 is on (e.g., the switch 208 has closed the circuit between the battery 206 and the bulb 204), the diode 207 prevents current a voltage signal (or current) from reaching the stopwatch 120. However, when the switch 208 is opened (e.g., by a press of the dome of the tap light 110) the diode 207 allows a transient voltage signal to pass that is capable of signaling the stopwatch 120 to cease keeping time.

Referring now to FIG. 3, a flow chart 300 illustrating one method of operation of the invention of the present disclosure is disclosed. In the present embodiment, utilizing a system such as that described with respect to FIG. 1 or 2, a timing game or exercise may be performed by two users. At step 302 a first user ensures that the tap light 110 is initially on, and the stopwatch 120 is on and set (reset) to zero to begin keeping time. At step 304, the first user then presses the momentary switch 222, which both sounds the buzzer 224, and starts the stopwatch 120. A second user (or contestant) is alerted that time has begun tolling, but watching the first user and/or hearing the buzzer 224, and at step 306 seeks to press the tap light 110 as quickly as possible. This press on the tap light 110 turns the tap light 110 off via switch 222, and causes a voltage signal to be provided to the stopwatch 120, which stops the timing function. The time showing on the stopwatch 120 is now indicative of the reaction time of the second user (contestant). It will be appreciated that the time required for the voltage signal to reach the stopwatch 120, and for the stopwatch 120 to cease accumulating time, is negligible in comparison to the reaction time of the second user (contestant). Furthermore, the exercise may be repeated, as shown by path 308 in the flowchart, but resetting the tap light 110 and stopwatch 120, and repeating the additional steps.

It should be understood that, in the present method and those described below, a press of the tap light 110 (e.g., step 306) is not necessarily a press by hand. For example, the tap light 110 could be located such a press with a user's foot or other body part activates (turns on or off) the tap light 110. Similarly, as described above, other implements such as weights, balls, mallets, or tethered items may be used to turn the tap light 110 on or off.

Referring now to FIG. 4, a flow chart illustrating another method 400 of operation of the invention of the present disclosure is shown. The method 400 of FIG. 4 does not require two users, rather the contestant functions as the only user of the system. At step 402 the user/contestant verifies that the tap light 110 is on, and that the stopwatch 120 is reset and ready to begin keeping time. At step 404 the user presses the tap light 110. This turns off the tap light 110, while simultaneously providing a signal to the stopwatch 120 to begin keeping time, as explained above. Then, at step 406, the tap light 110 is pressed a second time, which turns the tap light 110 on but does not signal the stopwatch 120 to stop keeping time. Finally, at step 408, the user presses the tap light 110 for a third time, which turns the tap light 110 off and (because it was already on) provides a signal to the stopwatch 120 to cease its timekeeping function. Because the sequence of events of steps 404, 406, and 408 provide only two start/stop signals to the stopwatch 120, the stopwatch 120 has taken measure of the elapsed time from the first press (step 404) to the third (step 408). Hence the time required to press the tap light 110 three times has been measured in the present embodiment. It will be appreciated that the tap light 110 may be reset, along with the stopwatch 120, and the method repeated as shown by 410.

Referring now to FIG. 5, a schematic diagram of another embodiment of the invention of the present disclosure is shown. The system 500 is similar to the system 200 previously described. However, in this embodiment, a second tap light 505 has been included. The tap light 505 may be considered to be “in parallel” with the first tap light 110. The tap light 505 has a bulb 504, a battery, 506, and a switch 508, activated by the dome of the tap light 505. Here again, the switch 508 is a SPST switch that selectively completes the circuit between the battery 506 and bulb 508. The switch is connected in a signaling capacity to the stopwatch 120. The positive terminal of the battery 506 is also connected to the stopwatch 120 through a diode 507, which, like the diode 207 prevents signaling to the stopwatch 120 under steady state operating conditions but allows a signal to be provided to the stopwatch 120 when the tap light 505 is switched from on to off.

Referring now to FIG. 6, a flow chart 600 illustrates one method of operation of the invention of the present disclosure as shown in FIG. 5. At step 602, the user ensures that both tap lights 110, 505 are on and the stopwatch 120 is reset and ready to begin timing. A press of the first tap light 110 at step 604 turns the tap light 110 off, and provides a signal to the stopwatch 120 that starts the stopwatch 120. A press of the second tap light 505 at step 606 turns the second tap light 505 off and provides a signal to the stopwatch 120 that stops the stopwatch 120. Thus, the time between the presses on the different tap lights 110, 505 is recorded. It will be appreciated that the tap lights 110, 505 may be located some distance apart, or mounted in specific orientations to provide timing of specific events or movements by the user. Furthermore, in the configuration shown in FIG. 5, either tap light 110, 505 can be pressed first to start the stopwatch 120 and pressing the other tap light will stop the stopwatch 120. Path 608 of the flow chart 600 illustrates that the stopwatch may be reset, and the tap lights 110, 505 turned back on, and the method can be repeated.

Although the instant invention in some embodiments utilizes a wired connection between the tap light 110 and stopwatch 120, a hardware interconnection is not required. More generally, these two components may be placed into communication wirelessly and events that are received in one device (e.g., a tap on the tap light 110) can trigger a transmitted signal of same to the other device. In this scenario, it might be expected that the tap light 110 and stopwatch 120 would be augmented by, for example, a Bluetooth transceiver. Additionally, in some embodiments each device will additionally be fitted with some sort of programmable logic device (e.g., a microprocessor, microcontroller, CPU, gate array, etc.) to monitor the associated switch(es) of that device for events such as switch presses, taps, etc. and transmit an indicium of that event to the other device.

FIG. 7 contains a schematic illustration of such an embodiment 700. In this case, the stop watch/timer 720 is able to communicate wirelessly with the tap light 710. The various operations are the same as have been discussed previously, except that the timer 720 and the tap light 710 are each provided with some means of wireless communications (e.g., Bluetooth, WiFi, RF (radio frequency), IR (infrared), etc.) over which to communicate events and/or status. As such, when the term “wireless communication” is used herein, that term should be broadly construed to include any conventional or unconventional means of communicating wirelessly between two devices. Note that in some embodiments the communication between devices might be two way, in other embodiments it might be one way (e.g., from the tap light 710 to the timer).

FIG. 8 contains an illustration of another aspect of the instant invention. In this embodiment, the tap light 805 operates with an associated wired or wireless timing device (not shown) as before, but it is situated within a structure that is designed to protect it from heavy blows. In one embodiment, the instant invention might be utilized in connection with tossing a relatively heavy object such as a basketball, football, etc. Since tap lights of the sort utilized some embodiments of the instant invention might be too fragile to stand up to blows from heavier objects, the embodiment of FIG. 8 illustrates how such could be protected by a targeting shield 810 which might be made of Plexiglas or another transparent or translucent material. Additionally, in this embodiment a support surface 820 is provided on which to rest the tap light 805.

In one variation, the tap light 805 will be placed between targeting 810 and support 820 surfaces and further protected by one or more barriers 825 in FIG. 8 which will serve to limit the downward motion of upper surface 810 in the event of a heavy blow thereto, the barriers being designed to limit the downward movement of the targeting shield toward the tap light 805. Additionally, in an embodiment the upper surface 810 will be mounted on a plurality of adjustable spring-type connectors 815 which are designed to provide rebound to the upper surface 810 after a blow.

Additionally, in some embodiments, the connectors 815 will be fitted with an internal screw mechanism that, together with some number of washers (not shown) will allow the connectors 815 to be made adjusted in height to vary the tension in the springs 830 and accommodate tap lights 805 of different heights. Although a coil spring 830 has been used to illustrate one means of giving the upper surface some amount of rebound after a blow, those of ordinary skill in the art will recognize that any other structure or substance with some amount of resiliency (e.g., foam or rubber blocks, leaf springs, flat springs, v spring, etc.) could be used in the alternative.

The barriers 825 and springs 830 will be configured so that the target surface 810 can descend to the point where the tap light 805 is depressed sufficiently to trigger it, but not far enough to cause it damage. Additionally, the springs 830 will operate to reduce the downward velocity of the target surface 810 to minimize the chance of a substantial impact to the tap light 805. For purposes of the claims that follow, the terms resilient spacer will be used to describe the connectors 815 and variations thereof.

Finally, in some embodiments, a target image will be inscribed on all or part of the upper surface 810 which will serve as a focusing point for participants in the event.

Thus, the present invention is well adapted to carry out the objectives and attain the ends and advantages mentioned above as well as those inherent therein. While presently preferred embodiments have been described for purposes of this disclosure, numerous changes and modifications will be apparent to those of ordinary skill in the art. Such changes and modifications are encompassed within the invention as defined by the claims.

What is claimed is:

1. A system comprising:
an electronic timer; and
a switchable light source in electrical communication with the timer that provides a start/stop signal to the timer when the light source is switched from an on, illuminated state to an off state.

2. The system of claim 1, wherein the switchable light source is a tap light having a dome that is actuatable by a user to selectively switch the tap light between the illuminated state and the off state.

3. The system of claim 2, further comprising a diode that interposes a connection between the tap light and the electronic timer to prevent signaling of the electronic timer except when the tap light is switched from the illuminated state to the off state.

4. The system of claim 3, wherein the tap light contains a first battery, a bulb, and a switch operatively connected to the dome, the switch completing a circuit between the first battery and the bulb when the dome is pressed.

5. The system of claim 4, further comprising:
a buzzer;
a second battery; and
a dual pole, dual throw momentary switch connected to complete a circuit between the buzzer and second battery, and provide a start signal to the stopwatch from the first battery when pressed.

6. The system of claim 5, wherein the timer is a stopwatch.

7. The system of claim 6, wherein the stopwatch, second battery, buzzer, and momentary switch are affixed to a housing that is spaced apart from the tap light and attached thereto by at least one electrical lead.

8. The system of claim 1, further comprising a second switchable light source that is also attached to the timer and provides a start/stop signal to the timer when the light source is switched from an on, illuminated state to an off state.

9. The system of claim 1, wherein said electrical communication between said electronic timer and said switchable light source is conducted over a wire.

10. The system of claim 1, wherein said electrical communication between said electronic timer and said switchable light source is conducted wirelessly.

11. The system of claim 2, further comprising:
a support surface,
a targeting surface spaced apart from said support surface by a plurality of resilient spacers, wherein
said switchable light source is positioned between said targeting surface and said support surface,
said switchable light source is in continuous contact with said support surface, and said targeting surface is movable with respect to said support surface to contact said switchable light.

12. A device comprising:
a first light source that provides an electrical signal when switched from on to off, but no electrical signal when switched from off to on; and
a timer that receives the electrical signal as an indication to begin keeping time if stopped and to stop keeping time if already doing so.

13. The device of claim 12, wherein the first light source is a tap light with an internal battery connected to the timer via a diode for preventing an outgoing electrical signal under steady state signal but allowing an outgoing electrical signal when the tap light is turned from on to off.

14. The device of claim 13, further comprising a second tap light with an internal battery connected to the timer via a diode for preventing an outgoing electrical signal under steady state signal but allowing an outgoing electrical signal when the tap light is turned from on to off.

15. The device of claim 12 further comprising a switch actuated buzzer that provides an electrical signal to the timer.

16. The device of claim 15, further comprising a housing that receives the timer and switch actuated buzzer and connects to the first light source remotely.

17. The device of claim 12, wherein the timer comprises a stopwatch.

18. A method comprising:
turning on a light source
simultaneously activating a buzzer and starting a timer with a single momentary switch;
simultaneously providing a stop signal to the timer and turning off the light source with a light switch spaced apart from the timer.

19. The method of claim 18, wherein simultaneously providing a stop signal to the timer and turning off a light source comprises pressing a tap light.

20. A method comprising:
turning on a light source;
simultaneously turning on a timer and turning off the light source by using a single light switch that provides an output signal to the timer when turned from on to off but not off to on;
turning the light back on with the light switch; and
turning the light back off and stopping the timer using the light switch.

21. The method of claim 20 wherein the light switch is actuated by pressing a tap light.

22. A method comprising:
turning on first and second light sources;
simultaneously starting a timer and turning off the first light source by using a first light switch that provides a first output signal to the timer when turned from on to off but not off to on; and
simultaneously stopping the timer and turning off the second light source by using a second light switch that provides a second output signal to the timer when turned from on to off but not off to on.

23. The method of claim 22, wherein the first and second output signals to the timer are provided in response to pressing first and second tap lights, respectively.
